(19) United States
(12) Patent Application Publication
(10) Pub. No.: US 2005/0280865 A1
(43) Pub. Date: Dec. 22, 2005

(54) Image reading unit, image processing apparatus, image forming apparatus, image processing method, and computer product

(76) Inventor: Sugitaka Oteki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/142,451

(22) Filed: Jun. 2, 2005

(30) Foreign Application Priority Data
Jun. 3, 2004 (JP) 2004-166194

(51) Int. Cl. H04N 1/40

(52) U.S. Cl. 358/2.1

(57) ABSTRACT

An image reading unit includes a document determining unit that generates both multi-value data of color components of RGB and binary data indicating black or white as a black component by scanning a document once with one reading unit for an image of a document, stores the multi-value data and the binary data in a storing unit, and determines whether the document is a monochrome document or a color document; and a data processing unit that, when the document determining unit determines that the document is a monochrome document, selects the binary data stored to process the binary data as valid data, and when the document determining unit determines that the document is a color document, selects the multi-value data stored to process the multi-value data as the valid data.

### CROSS-REFERENCE TO RELATED APPLICATIONS

The present document incorporates by reference the entire contents of Japanese priority document, 2004-166194 filed in Japan on Jun. 3, 2004.

### BACKGROUND OF THE INVENTION

1) Field of the Invention

The present invention relates to a technology for reading image data of a document, storing the image data, and reproducing the image data on a recording medium.

2) Description of the Related Art

As technologies of this type, the present invention disclosed in, for example, Japanese Patent Application Laid-Open No. 2003-162382 is known publicly. This invention relates to a color multifunction product. The color multifunction product is constituted as described below to process image data of a document and obtain a transferred image.

FIG. 7 is a schematic of a structure for internal processing of an image processing unit (IPU) 3 that has been used conventionally. The IPU 3 includes a scanner image processing unit 301, a printer image quality processing unit 302, and a command control unit 44.

The scanner image processing unit 301 includes an input interface (I/F) 30, a shading correction unit 31, a document-detection automatic-color-select (ACS) unit 32, a scanner γ processing unit 33, a filter 34, a binarization unit 35, a packing unit 36, a color correction unit 37, a selector 38, and an output I/F 39. The printer image quality processing unit 302 includes an input I/F 40, a printer γ processing unit 41, a gradation processing unit 42, and an output I/F 43.

The command control unit 44 receives a result of detection by the document detection ACS unit 32 via a not-shown serial bus and outputs the detection result to the serial bus side.

In the IPU 3 constituted as shown in FIG. 7, document image data input from a sensor board unit (SBU; see FIG. 1) is captured through the input I/F 30. The document image data is transferred to the shading correction unit 31, the scanner γ processing unit 33, and the filter 34. Thereafter, when an image is copied, the selector 38 selects data, which is obtained by processing the document image data in the color correction unit 37, and transfers the data to an image-data control unit (CDIC; see FIG. 1) through the output I/F 39.

In a binarization mode of a scanner application, data subjected to filter processing by the filter 34 is transferred to the binarization unit 35 and the packing unit 36. The selector 38 selects data after packing and transfers the data to the CDIC through the output I/F39.

In a multi-value mode of the scanner application, the selector 38 selects multi-value data of RGB (Red, Green, and Blue) after filter processing and transfers the data to the CDIC through the output I/F 39.

The document detection ACS unit 32 monitors RGB data after shading, judges whether a document is a monochrome document or a color document, and sends a result of the judgment (an ACS result) to the command control unit 44.

The ACS result sent to the command control unit 44 is read out by a process controller and, then, transmitted to a system controller.

On the other hand, when a copy is printed, image data from the CDIC is captured through the input I/F 40, sent to the printer γ processing unit 41, the gradation processing unit 42, and the output I/F 43, and output to a video-data control unit (VDC; see FIG. 1).

FIG. 8 is a schematic of the selector 38 shown in FIG. 7. FIG. 9 is a table of signals output to four channels 0 to 3, according to an output selection signal SEL shown in FIG. 8.

As shown in FIGS. 8 and 9, when a selection signal SEL is ‘0’, binary signals of RGB for the scanner application and invalid data are output to the channels 0, 1, 2, and 3, respectively. When the selection signal SEL is ‘1’, multi-value signals of RGB for the scanner application and invalid data are output to the channels 0, 1, 2, and 3, respectively. When the selection signal SEL is ‘2’, multi-value signals of CMYK (Cyan, Magenta, Yellow, and Black) for the copy printing are output to the channels 0, 1, 2, and 3, respectively.

As shown in FIG. 8, in the binary mode of the scanner application, binary data of RGB are selected and output to the channels 0, 1, and 2, respectively. FIG. 10A shows an image format in the binary mode. In this image format, data having two values for one pixel is subjected to packing for eight pixels. For Red, a first pixel is R0, a second pixel is R1, and an eighth pixel is R7.

Similarly, for Green, a first pixel is G0, a second pixel is G1, and an eighth pixel is G7.

Moreover, for Blue, a first pixel is B0, a second pixel is B1, and an eighth pixel is B7. FIG. 11A shows how the data are stored in a memory (MEM) 17 in the binary mode. The storage areas for RGB are secured on the memory and the data are stored in the storage areas, respectively.

In the multi-value mode of the scanner application, multi-value data, 8 bit data in this example, of RGB are selected and output to the channels 0, 1, and 2, respectively. FIG. 10B shows an image format in the multi-value mode. In this image format, data having 8 bits for one pixel are shown.

FIG. 11B shows how the data are stored in the memory (MEM) 17.

The storage areas for RGB are secured on the memory. Since one pixel to be stored has multiple values, the storage areas are larger than those for two values in FIG. 11A.

In copying an image, multi-value data of CMYK, 8 bit data in this example, are selected and output to the channels 0, 1, 2, and 3, respectively. FIG. 10C shows an image format in the copying. In this image format, data having 8 bits for one pixel are shown. FIG. 11C shows how the data are stored in the memory (MEM) 17.

In the scanner application for taking images of read documents into a hard disk (HDD) or a personal computer (PC) on a controller side (see FIG. 1), when monochrome documents and color documents are mixed in the documents, there is a strong demand for capturing monochrome document data as monochrome binary data and capturing color document data as multi-value data of RGB. This is because an operator considers that two values of black and white are sufficient for the monochrome documents but wishes to read color information of the color documents clearly. FIG. 12 is a flowchart of a processing procedure on the controller side in the automatic color select (ACS) function in the scanner application that has been used conventionally.

The image processing unit starts reading a document (step S101) and, when the document reading ends (step S102), reads an ACS result (step S103) and judges whether the document is a color document (step S104).

Conventionally, when an operator sets the processing in this way, the selector 38 shown in FIGS. 7 and 8 selects multi-value data of RGB and temporarily stores the data in the memory (MEM) on the controller side. In this case, the document detection ACS unit 32 judges whether the read document is a monochrome document or a color document. However, usually, the document detection ACS unit 32 cannot perform the detection unless the document is read to the end. This is because, for example, when a seal is affixed to a monochrome document, color information may be present at an edge of the document. A result of document detection ACS concerning whether the document is a monochrome document or a color document is read by accessing the command control unit 44 in FIG. 7 with a process controller and, then, transferred to a system controller (see FIG. 1).

If the read document is a color document (“Yes” at step S104), the image processing unit uses the multi-value data of RGB stored in the memory directly (step S105). In general, such color multi-value data is converted into a general-purpose format like JPEG by the PC.

On the other hand, if the read document is a monochrome document (“No” at step S104), the image processing unit uses the multi-value data of Green (G) stored in the memory and executes conversion into monochrome binary data according to software processing by the system controller or the PC to obtain image data required by the operator (steps S106 and S107).

In the case of the method as indicated by the publicly-known example, when the read document is a color document, necessary data is obtained at relatively high speed because the multi-value data of RGB are used directly. However, when the read document is a monochrome document, it takes long to obtain necessary image because the multi-value data are converted into binary data according to software processing. In addition, since the processing is performed by software, binarization processing by a complicated algorithm cannot be used and a method of software processing, which only requires relatively short time, like simple binarization is used to execute the processing. Thus, an image quality after the binarization processing is low.

For example, when multi-value data is represented by 8 bits, one pixel is represented by a value from 0 to 255. The simple binarization is a method of setting a threshold value to 128 as an example and, when a value of pixel data is equal to or larger than this threshold value, treating the pixel data as “1” indicating a black pixel and, when a value of pixel data is smaller than the threshold value 128, treating the pixel data as “0” indicating a white pixel.

When the binarization processing is performed by software according to error diffusion processing or dither processing that provides a better image quality than the simple binarization, an algorithm of the binarization processing is complicated. Thus, it takes long to obtain necessary image and document reading speed cannot be improved.

In addition, conventionally, multi-value data of RGB are stored in a memory and, when a document is a color document, the RGB data stored in the memory are used, and when a document is a monochrome document, the simple binarization processing is performed by software based on G data in the RGB data. In this case, since the binarization processing is performed according to software processing and a simple algorithm, long time is required for the binary processing and an image quality is low. To improve the image quality, it is necessary to perform binarization according to an algorithm such as the dither processing or the error diffusion processing. However, since workload of the dither processing and the error diffusion processing is too large for the software, long time is required for the binarization processing. Thus, the binarization according to the dither processing or the error diffusion processing is not realistic. In the case of monochrome multi-thresholding, workload is larger than that of the binarization.

Moreover, even when a document is monochrome, only multi-value data is transmitted according to the conventional technology. Thus, a general-purpose binarization format cannot be realized and it is required to convert the multi-value data into a necessary format after binarization.

### SUMMARY OF THE INVENTION

It is an object of the present invention to solve at least the above problems in the conventional technology.

An image reading unit according to one aspect of the present invention includes a document determining unit that generates both multi-value data of color components of Red, Green, and Blue and binary data indicating black or white as a black component by scanning a document once with one reading unit for an image of a document, stores the multi-value data and the binary data in a storing unit, and determines whether the document is a monochrome document or a color document; and a data processing unit that, when the document determining unit determines that the document is a monochrome document, selects the binary data stored to process the binary data as valid data, and when the document determining unit determines that the document is a color document, selects the multi-value data stored to process the multi-value data as the valid data.

An image reading unit according to another aspect of the present invention includes a document determining unit that generates first multi-value data of color components of Red, Green, and Blue and second multi-value data of a black component by scanning a document once with one reading unit for an image of a document, stores the first multi-value data and the second multi-value data in a storing unit, and determines whether the document is a monochrome document or a color document; and a data processing unit that, when the document determining unit determines that the document is a monochrome document, selects the second multi-value data stored to process the second multi-value data as valid data, and when the document determining unit determines that the document is a color document, selects the first multi-value data stored to process the first multi-value data as valid data.

An image processing apparatus according to still another aspect of the present invention includes an image reading unit including a document determining unit that generates both multi-value data of color components of Red, Green, and Blue and binary data indicating black or white as a black component by scanning a document once with one reading unit for an image of a document, stores the multi-value data and the binary data in a storing unit, and determines whether the document is a monochrome document or a color document, and a data processing unit that, when the document determining unit determines that the document is a monochrome document, selects the binary data stored to process the binary data as valid data, and when the document determining unit determines that the document is a color document, selects the multi-value data stored to process the multi-value data as the valid data; and an image processing unit that performs an image processing on image data read by the image reading unit. The image processing is for at least one of an image formation and an image recording.

An image processing apparatus according to still another aspect of the present invention includes an image reading unit including a document determining unit that generates first multi-value data of color components of Red, Green, and Blue and second multi-value data of a black component by scanning a document once with one reading unit for an image of a document, stores the first multi-value data and the second multi-value data in a storing unit, and determines whether the document is a monochrome document or a color document, and a data processing unit that, when the document determining unit determines that the document is a monochrome document, selects the second multi-value data stored to process the second multi-value data as valid data, and when the document determining unit determines that the document is a color document, selects the first multi-value data stored to process the first multi-value data as valid data; and an image processing unit that performs an image processing on image data read by the image reading unit. The image processing is for at least one of an image formation and an image recording.

An image forming apparatus according to still another aspect of the present invention includes an image processing apparatus including an image reading unit, and a data processing unit that, when the document determining unit determines that the document is a monochrome document, selects the binary data stored to process the binary data as valid data, and when the document determining unit determines that the document is a color document, selects the multi-value data stored to process the multi-value data as the valid data, and an image processing unit that performs an image processing on image data read by the image reading unit; and an image forming unit that forms a visible image on a recording medium based on the image data processed by the image processing apparatus. The image processing is for at least one of an image formation and an image recording.

An image forming apparatus according to still another aspect of the present invention includes an image processing apparatus including an image reading unit including a document determining unit that generates first multi-value data of color components of Red, Green, and Blue and second multi-value data of a black component by scanning a document once with one reading unit for an image of a document, stores the first multi-value data and the second multi-value data in a storing unit, and determines whether the document is a monochrome document or a color document, and a data processing unit that, when the document determining unit determines that the document is a monochrome document, selects the second multi-value data stored to process the second multi-value data as valid data, and when the document determining unit determines that the document is a color document, selects the first multi-value data stored to process the first multi-value data as valid data, and an image processing unit that performs an image processing on image data read by the image reading unit; and an image forming unit that forms a visible image on a recording medium based on the image data processed by the image processing apparatus. The image processing is for at least one of an image formation and an image recording.

An image processing method according to still another aspect of the present invention includes reading a document; determining, after a completion of the reading, whether the document is a color document; performing, when it is determined that the document is a color document at the determining, an image processing on color data of Red, Green, and Blue, which is read from the document and stored in a memory, as final data; and performing, when it is determined that the document is not a color document at the determining, an image processing on binarized data of black, which is read from the document and stored in a memory, as final data.

A computer-readable recording medium according to still another aspect of the present invention stores a computer program that makes a computer execute the above image processing method according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a system configuration of an image processing unit of an MFP according to an embodiment of the present invention;

FIG. 2 is a block diagram of a schematic structure of an IPU shown in FIG. 1;

FIG. 3 is a block diagram of a schematic structure of a CDIC shown in FIG. 1;

FIG. 4 is a block diagram of a schematic structure of a VDC shown in FIG. 1;

FIG. 5 is a block diagram of a schematic structure of an image-memory access control (IMAC) shown in FIG. 1;

FIG. 6 is a block diagram of an example of a structure of a facsimile transmission/reception unit (FCU) shown in FIG. 1;

FIG. 7 is a schematic of a detailed structure for internal processing of an IPU according to the present embodiment and a conventional example;

FIG. 8 is a schematic of a selector shown in FIG. 7;

FIG. 9 is a table of signals output from the selector shown in FIG. 7 according to an output selection signal SEL;

FIGS. 10A to 10C are diagrams of output image formats of a scanner application;

FIGS. 11A to 11C are diagrams of states in which data of the output image formats shown in FIGS. 10A to 10C are stored in a memory;

FIG. 12 is a flowchart of a processing procedure on a controller side in a document automatic selection (ACS) function in a conventional scanner application;

FIG. 13 is a table of a relation between a scanner application and four channels at the time when monochrome documents and color documents are mixed and monochrome document data is captured as monochrome binary data and color document data is captured as multi-value data of RGB;

FIG. 14 is a diagram of data format at the time when monochrome documents and color documents are mixed and monochrome document data is transferred to a memory as binary monochrome data and color document data is transferred to the memory as multi-value data of RGB;

FIG. 15 is a diagram of a state of memory mapping at the time when monochrome documents and color documents are mixed and monochrome document data is stored in a memory as monochrome binary data and color document data is stored as multi-value data of RGB;

FIG. 16 is a flowchart of a processing procedure at the time when monochrome documents and color documents are mixed and monochrome document data is stored in a memory as monochrome binary data and color document data is stored in the memory as multi-value data of RGB;

FIG. 17 is a table of a relation between a scanner application and four channels at the time when monochrome document data is captured as monochrome multi-value data and color document data is captured as multi-value data of RGB;

FIG. 18 is a diagram of a data format of data output from a selector when monochrome document data is transferred to a memory as monochrome multi-value data and color document data is transferred to the memory as multi-value data of RGB; and

FIG. 19 is a diagram of a state of memory mapping at the time when monochrome document data is stored in a memory as monochrome multi-value data and color document data is stored in the memory as multi-value data of RGB.

### DETAILED DESCRIPTION

Exemplary embodiments of the present invention are explained in detail below with reference to the accompanying drawings.

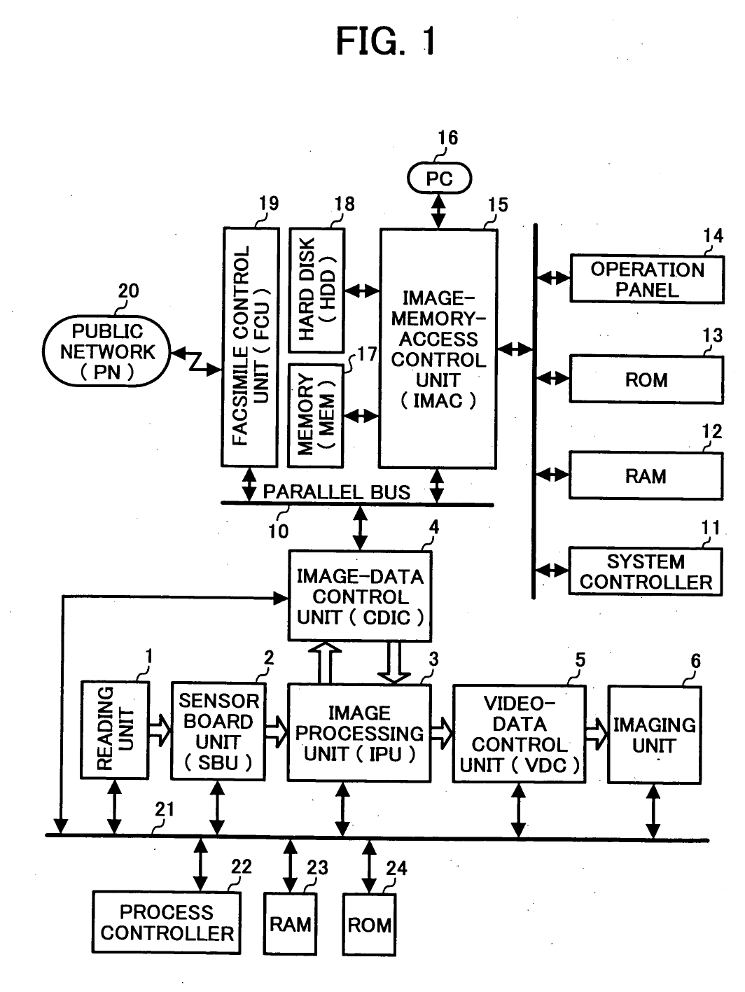

FIG. 1 is a block diagram of a system configuration of an image processing unit of an MFP according to an embodiment of the present invention. A reading unit 1, which reads a document optically, condenses reflected light from the document onto a light receiving element with a mirror and a lens. The light-receiving element (in the present embodiment, a charge-coupled device (CCD) is adopted as an example) is mounted on a sensor board unit (SBU) 2. An image signal converted into an electric signal in the CCD is converted into a digital signal and, then, output from the SBU 2.

The image signal output from the SBU 2 is transferred to an image processing unit (IPU) 3. Signal deterioration due to an optical system and quantization into a digital signal (signal deterioration of a scanner system) is corrected. Then, the image signal is input to a compression/decompression and data I/F control unit (CDIC) 4. The CDIC 4 controls transmission of all image data between functional devices and data buses. The CDIC 4 performs data transfer for image data among the SBU 2, a parallel bus 10, and the IPU 2 and communication between a system controller 11, which controls the entire system, and a process controller 22, which controls the image data).

The data transferred from the IPU 3 to the CDIC 4 is sent from the CDIC 4 to an image-memory access control (IMAC) 15 through the parallel bus 10. Based on the control of the system controller 11, the IMAC 15 performs access control for the image data and a memory (MEM) 17, expansion of print data of an external personal computer (PC) 16, and compression/decompression of the image data for effective utilization of a memory.

The data sent to the IMAC 15 is compressed and accumulated in the MEM 17. The IMAC 15 reads out the accumulated data as required. The IMAC 15 decompresses the read-out data to change the data to the document image data and returns the image data to the CDIC 4 through the parallel bus 10. After the image data is transferred from the CDIC 4 to the IPU 3, the image processing unit performs image quality processing by the IPU 3 and pulse control in a video-data control unit (VDC) 5 to form a reproduced image on transfer paper in an imaging unit 6.

In the flow of the image data, a function of an MPU is realized by bus control in the parallel bus 10 and the CDIC 4.

In a facsimile transmission function, the image processing unit subjects read image data to image processing in the IPU 3 and transfers the image data to a facsimile control unit (FCU) 19 through the CDIC 4 and the parallel bus 10. The image processing unit converts the image data into communication network data in the FCU 19 and transmits the image data to a public network (PN) 20 as facsimile data. In a facsimile reception function, the image processing unit converts line data from the PN 20 into image data in the FCU 19 and transfers the image data to the IPU 3 through the parallel bus 10 and the CDIC 4. In this case, the image processing unit performs dot rearrangement and pulse control in the VDC 5 without performing special image quality processing and forms a reproduced image on transfer paper in the imaging unit 6.

In a state in which plural jobs, for example, a copy function, a facsimile transmission and reception function, and a printer output function operate in parallel, the image processing unit controls allocation of rights of using a reading unit, an imaging unit, and a parallel bus to the jobs with the system controller 11 and the process controller 22.

The process controller 22 controls a flow of image data and the system controller 11 controls the entire system and manages startup of resources. An operator selects and inputs a function of the MFP on an operation panel 14 to set contents of processing of the copy function, the facsimile function, and the like. The system controller 11 and the process controller 22 communicate with each other via the parallel bus 10, the CDIC 4, and the serial bus 21. In the CDIC 4, the image processing unit performs data format conversion for data I/F between the parallel bus 10 and the serial bus 21.

In a scanner application, an image quality processing of image data of a document read by the reading unit 1 and the SBU 2 is performed by the IPU 3. The image processing unit sends the image data from the CDIC 4 to the memory (MEM) 17 or a hard disk (HDD) 18 via the parallel bus 10 and the IMAC 15 and stores the image data therein. The image processing unit sends the image data from the HDD 18 to the PC 16 as required.

A ROM 13 stores a computer program for the system controller 11. The system controller 11 executes the computer program stored in the ROM 13 using a RAM 12 as a work area. Similarly, a RAM 24 stores a computer program for the process controller 22. The process controller 22 executes the computer program stored in the ROM 24 using the RAM 23 as a work area.

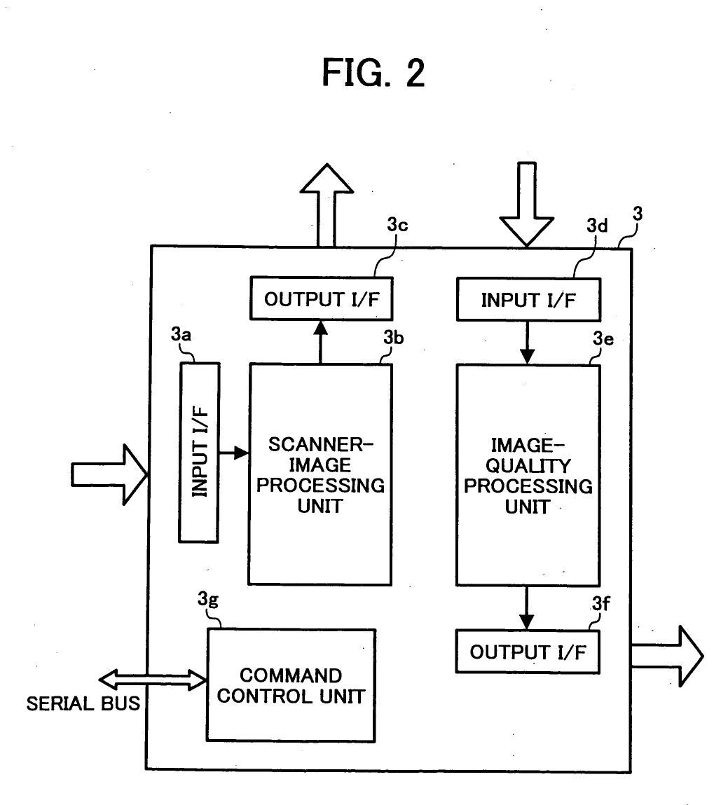

FIG. 2 is a block diagram of a schematic structure of the IPU 3 shown in FIG. 1. The IPU 3 transfers read image data from an input I/F 3a of the IPU 3 to a scanner image processing unit 3b via the SBU 2. For correcting deterioration of a read image signal, the scanner image processing unit 3b performs shading correction, scanner γ correction, MTF correction, and the like. Then, after finishing the correction processing for the read image data, the scanner image processing unit 3b transfers the image data to the CDIC 4 via the output I/F 3c.

The IPU 3 receives image data from the CDIC 4 in the input I/F 3d and performs area gradation processing in an image quality processing unit 3e. The IPU 3 outputs the data after the area gradation processing to the VDC 5 via an output I/F 3f.

The area gradation processing includes density conversion, dither processing, and error diffusion processing. Area approximation of gradation information is main processing. If image data subjected to scanner image processing is accumulated in the MEM 17 once, it is possible to confirm various reproduced images by changing the area gradation processing.

For example, it is possible to change a mood of a reproduced image by varying a density of the reproduced image or changing the number of lines of a dither matrix. In this case, it is unnecessary to read an image from a reading unit repeatedly every time the processing is changed. It is possible to apply different kinds of processing to identical data many times if a stored image is read out from the MEM 17.

In the case of a single scanner, the IPU 3 carries out the scanner image processing and the gradation processing simultaneously and outputs image data to the CDIC 4. The IPU 3 manages switching of processing, change of a processing procedure, and the like in the command control unit 3g.

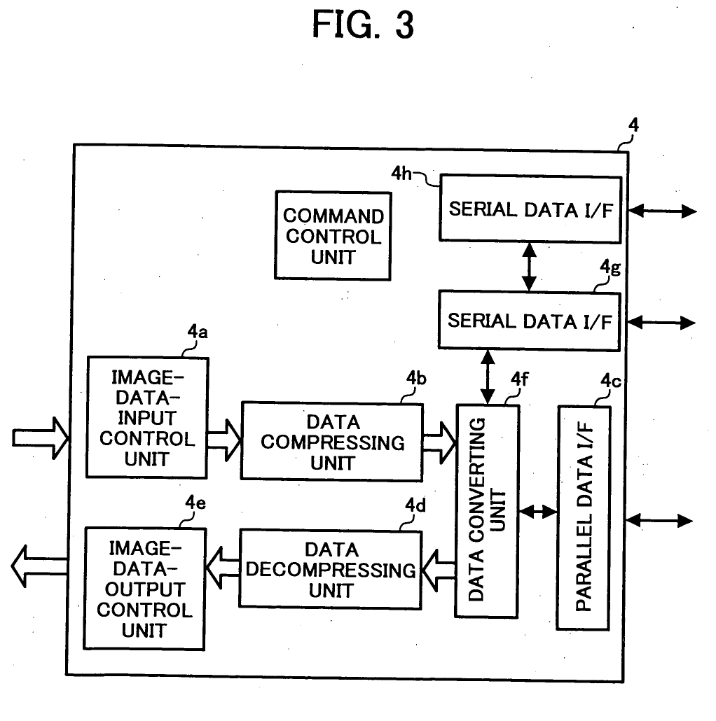

FIG. 3 is a block diagram of a schematic structure of the CDIC 4. Data subjected to the scanner image correction in the IPU 3 is input to the image data input control unit 4a. The CDIC 4 compresses the input data in a data compressing unit 4b to improve transfer efficiency in the parallel bus 10. Then, the CDIC 4 sends the data to the parallel bus 10 via a parallel data I/F 4c.

Since image data input from the parallel data bus 10 via the parallel data I/F 4c is compressed for bus transfer, the CDIC 4 decompresses the image data in a data decompressing unit 4d. The CDIC 4 transfers the decompressed image data to the IPU 3 through an image data output control unit 4e. Moreover, the CDIC 4 also has a function for converting parallel data and serial data. The CDIC 4 converts the parallel data and the serial data in a data converting unit 4f.

The CDIC 4 performs data conversion as described above in the data converting unit 4f for communication between the two controllers 11 and 22 because the system controller 11 transfers data to the parallel bus 10 and the process controller 22 transfers data to the serial bus 21. The CDIC 4 uses one of two systems of serial data I/Fs 4g and 4h for the IPU 3 and I/Fs with the IPU 3 as well.

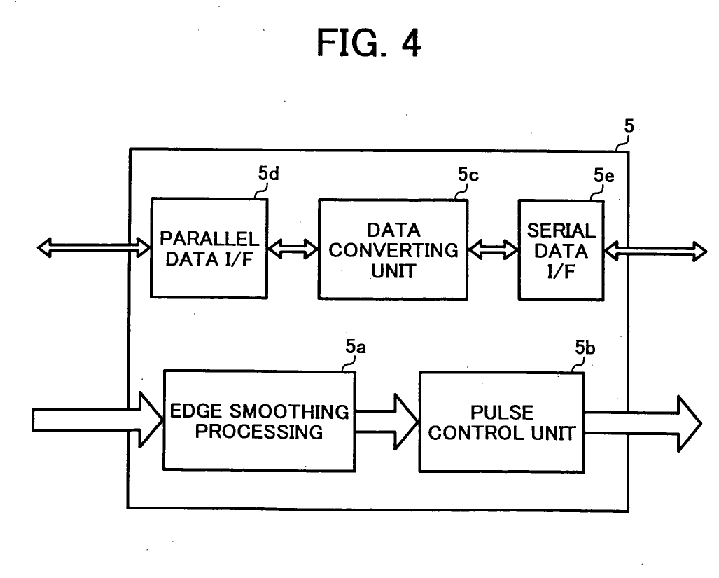

FIG. 4 is a block diagram of a schematic structure of the VDC 5. The VDC 5 applies additional processing to input image data according to a characteristic of the imaging unit 6. The VDC 5 performs dot rearrangement processing in an edge smoothing processing unit 5a and performs image signal pulse control for dot formation in a pulse control unit 5b. The VDC 5 outputs image data to the imaging unit 6.

The VDC 5 also has a format converting function for parallel data and serial data separately from image data converting function. The VDC 5 alone can cope with communication between the system controller and the process controller. Therefore, a parallel data I/F 5d and a serial data I/F 5e are connected to a data converting unit 5c.

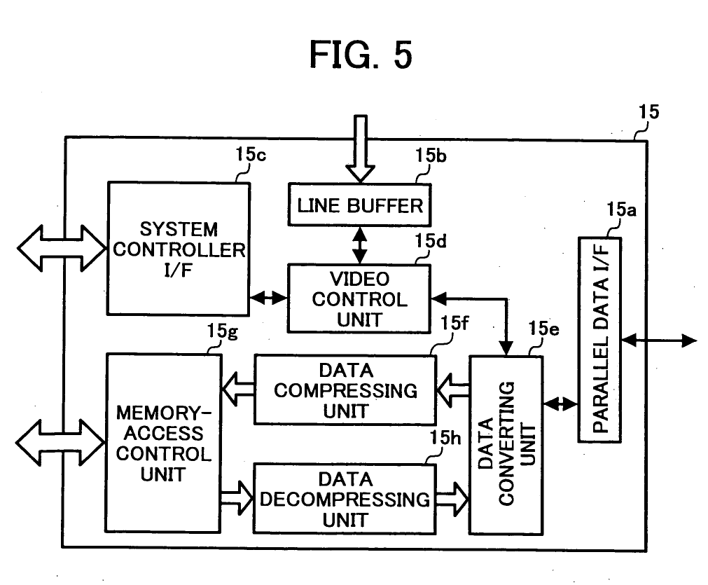

FIG. 5 is a block diagram of a schematic structure of the IMAC 15. The IMAC 15 manages I/F between the parallel bus and image data in a parallel data I/F 15a. In terms of a structure, the IMAC 15 controls storage of the image data in the MEM 17 and readout of the image data from the MEM 17 and expansion of code data mainly input from the external PC 16 to image data.

The IMAC 15 stores the input code data in a local area in a line buffer 15b. The IMAC 15 expands the code data stored in the line buffer 15b to image data in a video control unit 15d based on an expansion processing instruction that is input from the system controller 11 via a system controller I/F 15c.

The IMAC 15 stores the expanded image data or the image data input from the parallel bus 10 via the parallel data I/F 15a in the MEM 17. In this case, the IMAC 15 selects image data to be an object of storage in a data converting unit 15e, applies secondary compression to the image data to improve memory usage efficiency in a data compressing unit 15f, and stores the image data in the MEM 17 while managing an address of the MEM 17 in a memory access control unit 15g.

When the IMAC 15 reads out the image data stored in the MEM 17, the IMAC 15 controls a readout destination address in the memory access control unit 15 and decompresses the read-out image data in a data decompressing unit 15h. When the IMAC 15 transfers the decompressed image data to the parallel bus 10, data transfer is performed via the parallel data I/F 15a.

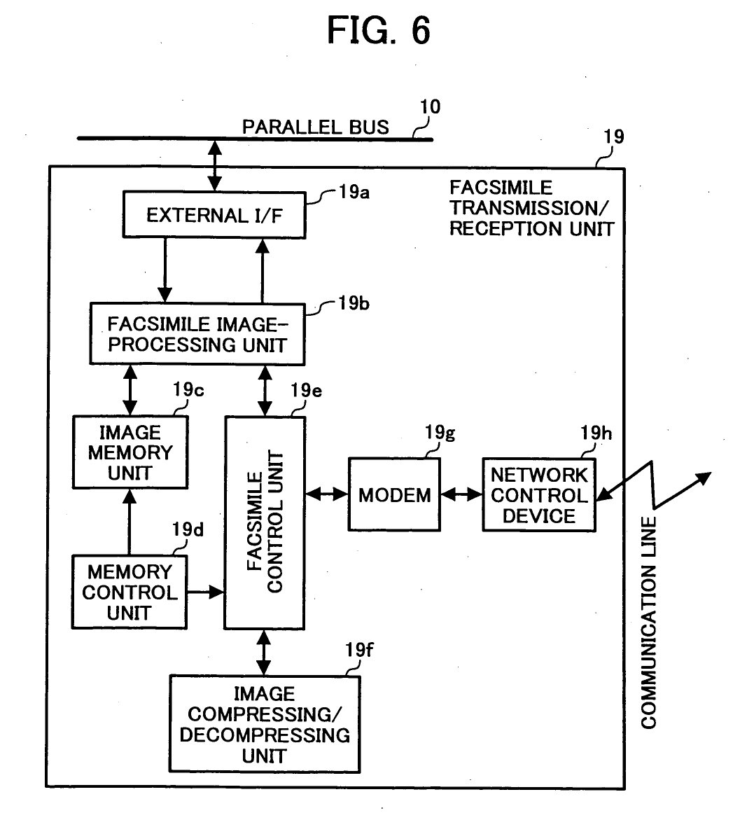

FIG. 6 is a block diagram of an example of a structure of the facsimile transmission/reception unit (FCU) 19. The facsimile transmission/reception unit 19 converts image data into data of a communication format and transmits the image data to an external line. In addition, the facsimile transmission/reception unit 19 converts data from the outside into image data and records and outputs the image data in the imaging unit 6 via an external I/F unit 19a and the parallel bus 10.

The facsimile transmission/reception unit 19 includes a facsimile image processing unit 19b, an image memory 19c, a memory control unit 19d, a facsimile control unit 19e, an image compressing/decompressing unit 19f, a modem 19g, and a network control device 19h. Concerning facsimile image processing, the facsimile transmission/reception unit 19 performs binary smoothing processing for a received image in the edge smoothing processing unit 5a in the VDC 5. In addition, concerning the image memory 19c, the facsimile transmission/reception unit 19 shifts a part of an output buffer function to the IMAC 15 and the MEM 17.

In the facsimile transmission/reception unit 19 constituted as described above, when the facsimile transmission/reception unit 19 starts transmission of image information, the facsimile control unit 19e instructs the memory control unit 19d to sequentially read out accumulated image information from the image memory 19c.

The read-out image information is restored to a document signal by the facsimile image processing unit 19b, subjected to density conversion processing and magnification processing, and applied to the facsimile control unit 19e. The image signal applied to the facsimile control unit 19e is subjected to code compression by the image compressing/decompressing unit 19f, modulated by the modem 19g, and transmitted to a destination via the network control device 19h. Then, when the transmission is completed, the image information is deleted from the image memory 19c.

When the facsimile transmission/reception unit 19 receives an image, the received image is temporarily accumulated in the image memory 19c. If it is possible to record and output the received image at that point, the facsimile transmission/reception unit 19 records and outputs an image for one sheet when reception of the image is completed. When the facsimile transmission/reception unit 19 receives a call and starts reception during a copying operation, the facsimile transmission/reception unit 19 accumulates image data in the image memory 19c until a usage rate of the image memory 19c reaches a predetermined value, for example, 80%. When the usage rate of the image memory 19c reaches 80%, the facsimile transmission/reception unit 19 forcibly suspends a writing operation executed at that point and reads out a received image from the image memory 19c and records and outputs the received image.

In this case, the facsimile transmission/reception unit 19 deletes the received image, which is read out from the image memory 19c, from the image memory 19c. When the usage rate of the image memory 19c falls to a predetermined value, for example, 10%, the facsimile transmission/reception unit 19 resumes the suspended writing operation. When the writing operation is completed, the facsimile transmission/reception unit 19 records and outputs remaining received images.

In addition, after suspending the writing operation, the facsimile transmission/reception unit 19 saves various parameters for the writing operation at the time of the suspension internally such that the writing operation can be resumed. When the writing operation is resumed, the facsimile transmission/reception unit 19 restores the parameters internally.

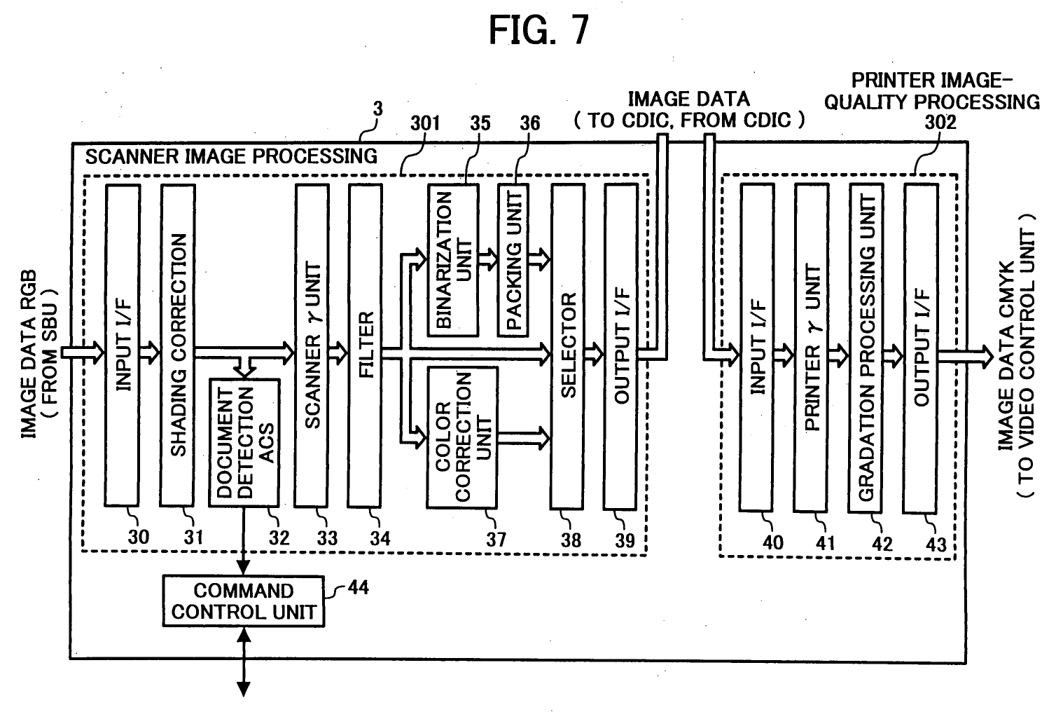

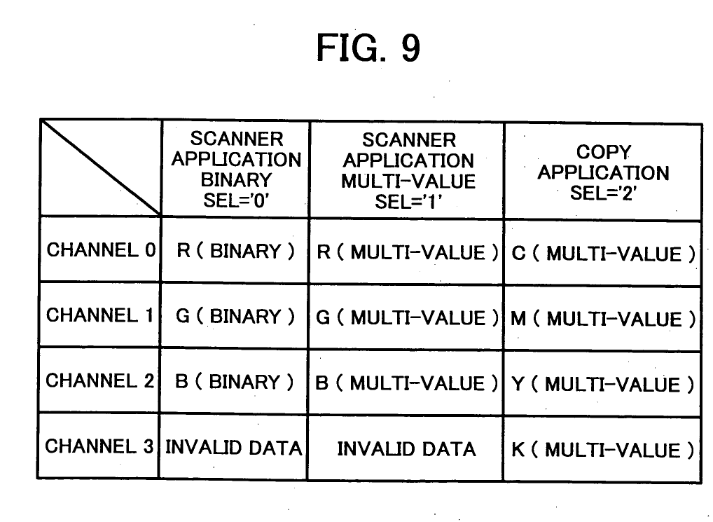

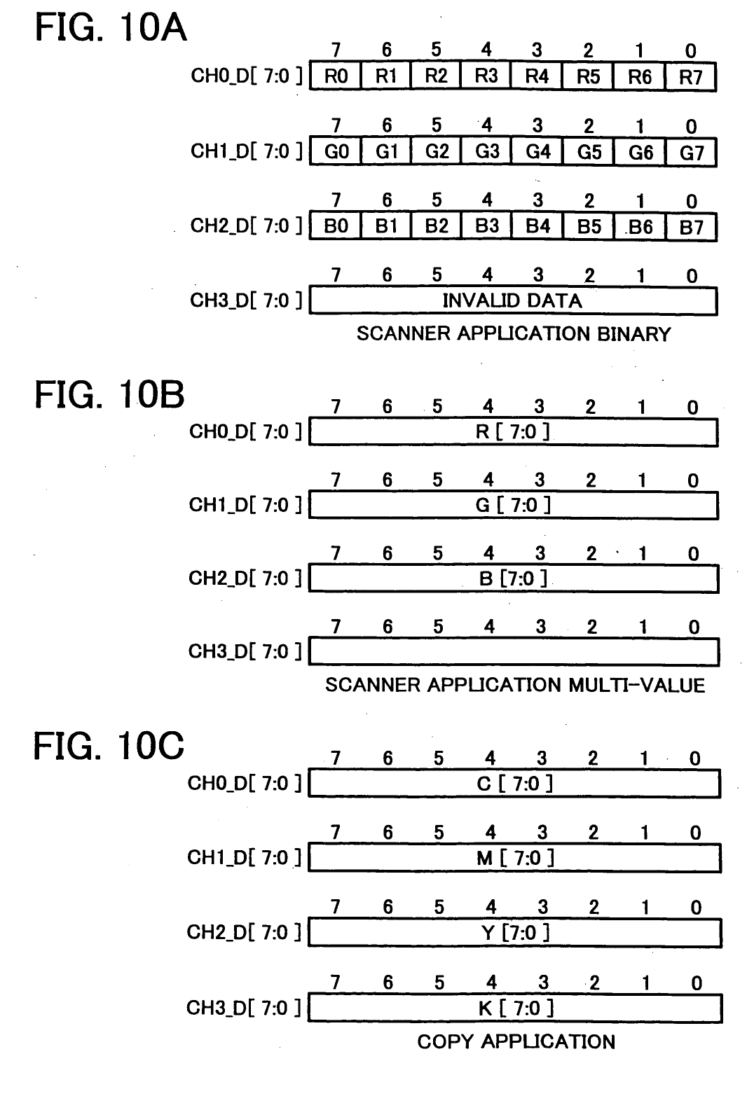

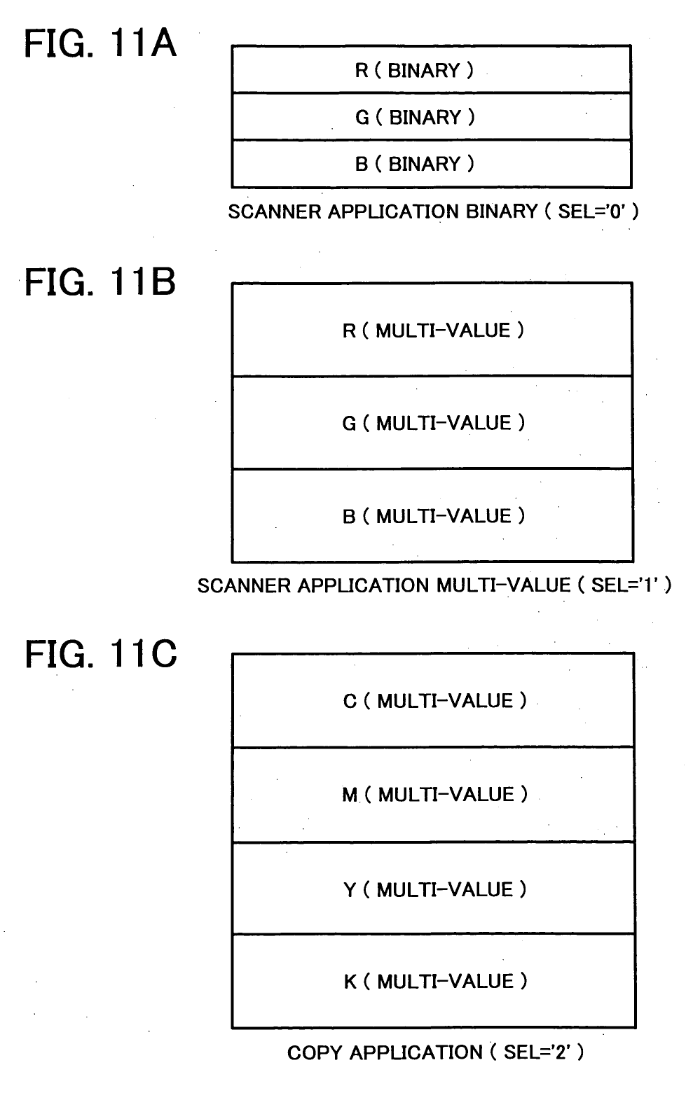

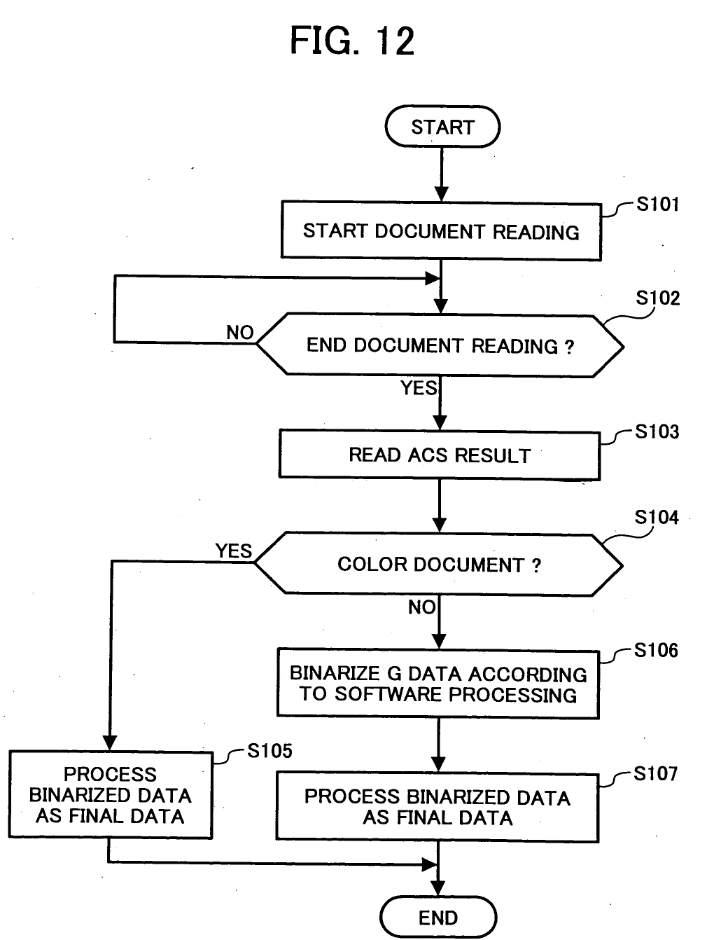

Since the units and the controls described in FIGS. 7 to 12 are configured in the same manner in the present embodiment, components equivalent to those shown in FIGS. 7 to 12 are denoted by the identical reference numerals and signs and redundant explanations are omitted.

In the image processing unit having the configuration of the units as described above, when monochrome documents and color documents are mixed in documents in the scanner application that takes an image of a read document into the hard disk (HDD) 18 and the PC 16 on the controller side, monochrome document data is captured as monochrome binary data and color document data is captured as multi-value data of RGB. An example of the present invention in this case is explained below.

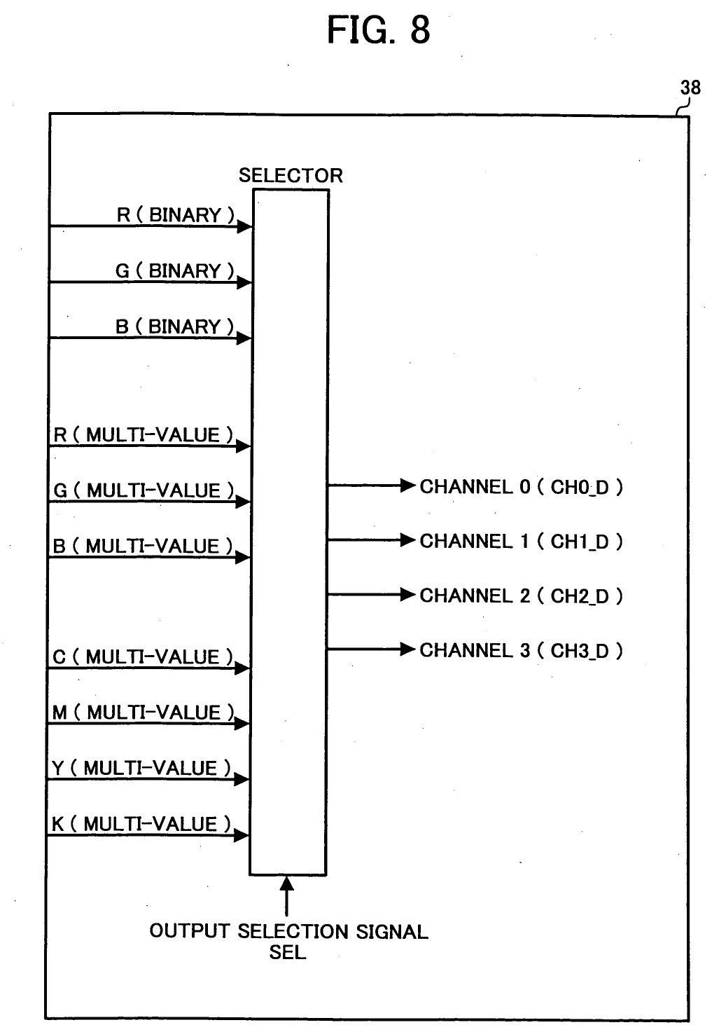

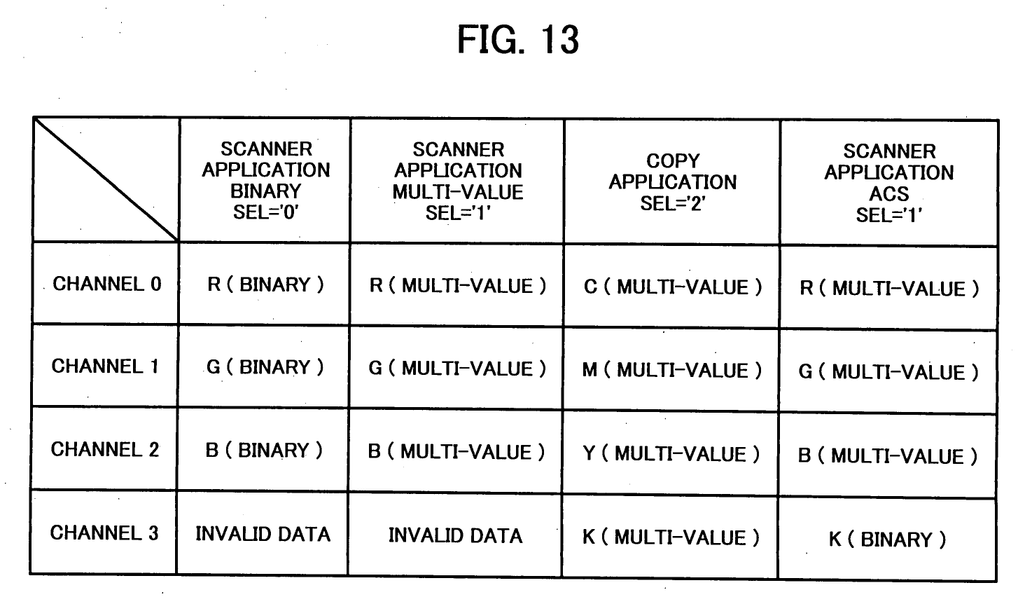

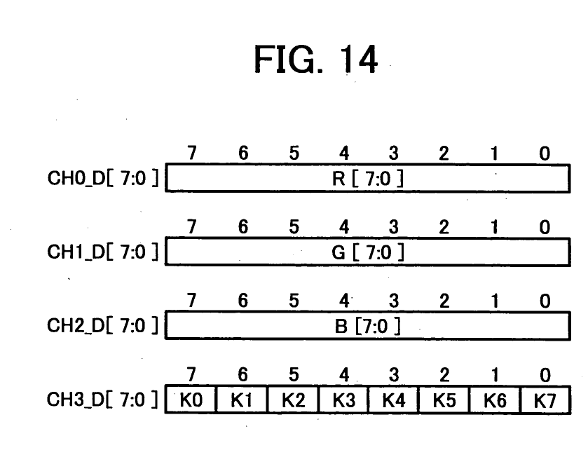

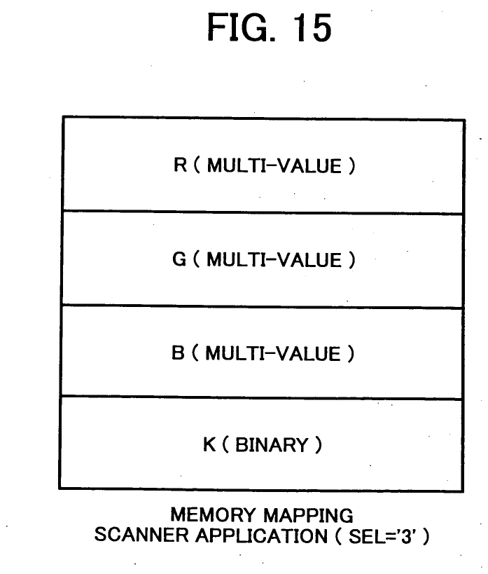

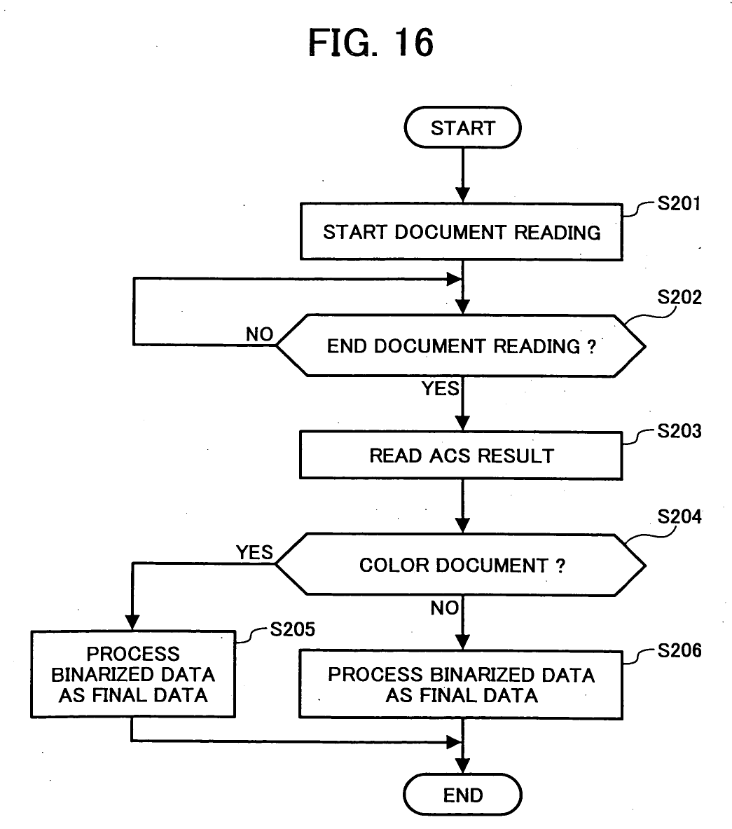

In this case, an ASC mode for the scanner application is provided as shown in FIG. 13. When SEL is ‘3’, the image processing unit causes the selector 38 shown in FIGS. 7 and 8 to output multi-value data of RGB from the filter 34 in FIG. 7 to the channels 0, 1, and 2 and output binary data of G after packing obtained by binarizing G data of RGB to the channel 3. Then, the image processing unit transfers and stores image data for these four channels in the memory (MEM) 17. FIG. 14 shows a data format of data output from the selector 38 in this case. FIG. 15 shows a state of mapping in the memory (MEM) 17 on the controller side. A processing procedure on the controller side in this case is as indicated by a flowchart shown in FIG. 16.

The image processing unit starts reading a document (step S201) and, when the document reading ends (step S202), reads out a result of automatic color select (ACS) (step S203) and judges whether the document is a color document (step S204).

When it is judged that the read document is a color document (“Yes” at step S204), the image processing unit uses the multi-value data of RGB stored in the MEM 17 and judges the binary data as invalid and discards the binary data (step S205).

On the other hand, when it is judged that the read document is a monochrome document (“No” at step S204), the image processing unit selects and uses the binary data of black (K) stored in the MEM 17 and judges the multi-value data of RGB as invalid and discards the multi-value data of RGB (step S206). Consequently, the software processing for conversion from the multi-value data of green (G) to the binary data is made unnecessary, which makes it possible to speed up the processing for obtaining necessary data. In addition, as the processing for conversion from multi-value data to binary data executed by the binarization unit 35 in FIG. 7, it is possible to select and execute the dither processing and the error diffusion processing that are pseudo-half tone processing. Thus, an image quality after binarization is also improved remarkably compared with the simple binarization.

When monochrome documents and color documents are mixed in documents in the scanner application that takes an image of a read document into the hard disk (HDD) 18 and the PC 16 on the controller side, monochrome document data is captured as monochrome multi-value data and color document data is captured as multi-value data of RGB. An example of the present invention in this case is explained below.

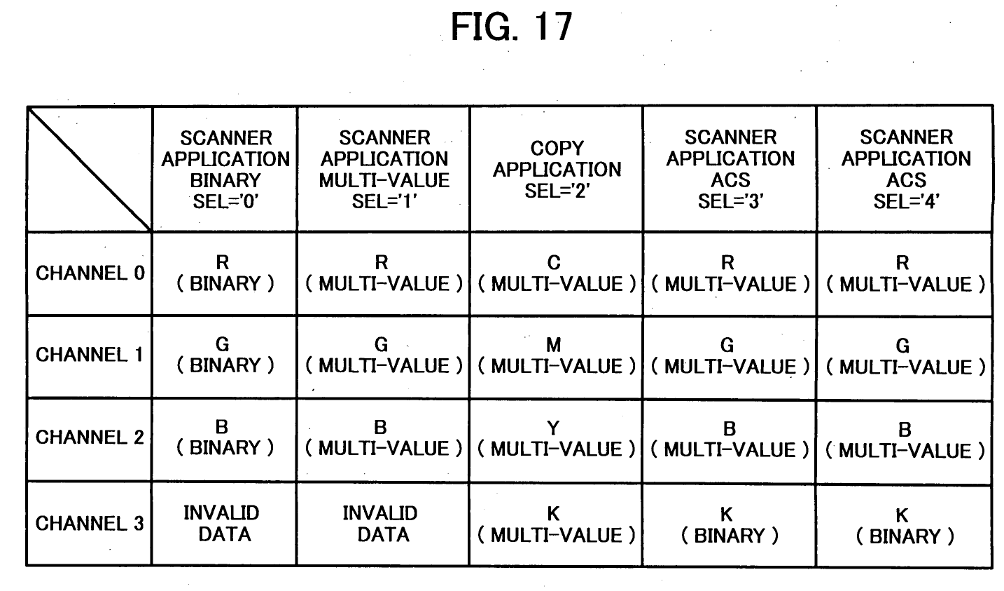

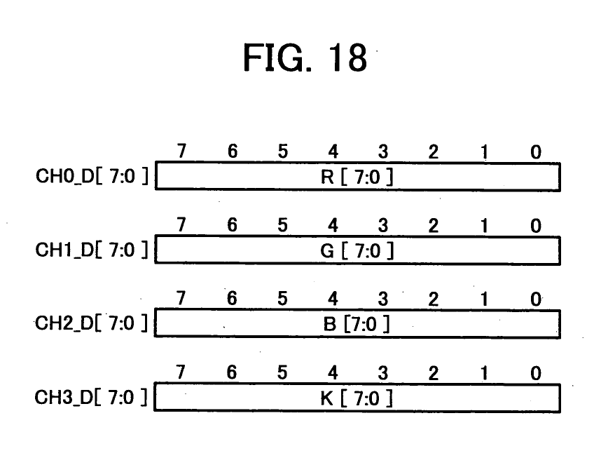

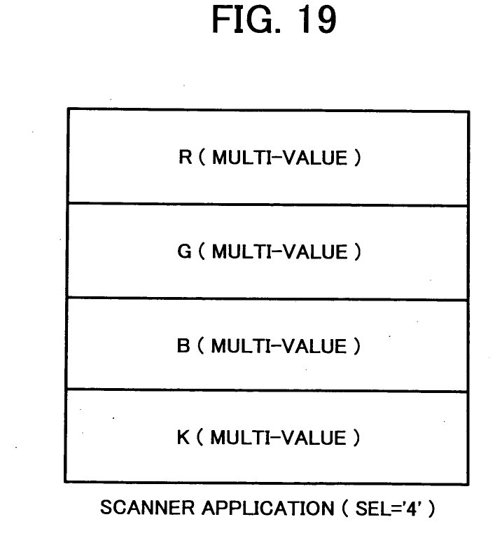

In this case, an ASC multi-value mode for the scanner application is provided as shown in FIG. 17. When SEL is ‘4’, the image processing unit causes the selector 38 shown in FIGS. 7 and 8 to output multi-value data of RGB from the filter 34 in FIG. 7 to the channels 0, 1, and 2 and output multi-value data of black (K), which is obtained by subjecting the multi-value data of RGB to optimum processing in a color correction block, to the channel 3. Then, the image processing unit transfers and stores image data for these four channels in the memory (MEM) 17. FIG. 18 shows a data format of data output from the selector 38 in this case. FIG. 19 shows a state of mapping in the memory (MEM) 17 on the controller side.

The image processing unit reads a document and judges whether the document is a color document. When it is judged that the read document is a color document, the image processing unit uses the multi-value data of RGB stored in the MEM 17. When it is judged that the read document is a monochrome document, the image processing unit selects and uses the multi-value data of black (K) stored in the memory (MEM) 17.

Consequently, as the processing for conversion from multi-value data of RGB to multi-value data of black executed by the color correction unit 37 in FIG. 7, it is possible to execute optimum processing including density conversion processing and thinning and thickening processing and output an image. Thus, it is possible to obtain a high-quality image at high speed.

According to the present embodiment, the image processing unit generates both multi-value data of color components of Red (R), Green (G), and Blue (B) and binary data indicating black or white as a black component by reading and scanning a document once with one reading unit for an identical image of a document. Then, the image processing unit transmits the multi-value data and the binary data to the memory (MEM) 17 and, at the same time, judges whether the read document is a monochrome document or a color document. When it is judged that the read document is a monochrome document, the image processing unit selects the stored binary data of a black component. On the other hand, when it is judged that the read document is a color document, the image processing unit selects the stored multi-value data of RGB and processes the multi-value data of RGB as valid image data. Thus, when color documents and monochrome documents are mixed and a user requests multi-value data of RGB when a document is a color document and requests monochrome binary data when a document is a monochrome document, it is possible to obtain necessary data at high speed and with high quality by scanning the document once.

The binary data of a black component is subjected to packing and transmitted to the memory. Thus, even when color documents and monochrome documents are mixed and a read document is monochrome, it is possible to suit a format of monochrome binary image data to a format of general-purpose binary data at high speed without software processing.

Moreover, the image processing unit generates multi-value data of color components of Red (R), Green (G), and Blue (B) and multi-value data of a black component by scanning a document once with one reading unit for an identical image of a document, transmits the multi-value data and the binary data to the memory (MEM) 17, and at the same time, judges whether the read document is a monochrome document or a color document. When it is judged that the read document is a monochrome document, the image processing unit selects the stored multi-value data of a black component. On the other hand, when it is judged that the read document is a color document, the image processing unit selects the stored multi-value data of RGB and processes the multi-value data of RGB as valid image data. Thus, when color documents and monochrome documents are mixed as documents to be read and a user requests multi-value data of RGB in the case of a color document and requests monochrome multi-value data in the case of a monochrome document, it is possible to obtain necessary data at high speed by scanning the documents once.

According to the present invention, when color documents and monochrome documents are mixed in read documents, it is possible to obtain necessary data at high speed by scanning the documents once even if a user requires multi-value data of RGB in the case of a color document and requires monochrome binary data or monochrome multi-value data in the case of a monochrome document.

Furthermore, according to the present invention, when color documents and monochrome documents are mixed and a read document is monochrome, it is possible to suit a format of monochrome binary image data to a general-purpose format of binary data.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An image reading unit comprising:
a document determining unit that generates both multi-value data of color components of Red, Green, and Blue and binary data indicating black or white as a black component by scanning a document once with one reading unit for an image of a document, stores the multi-value data and the binary data in a storing unit, and determines whether the document is a monochrome document or a color document; and
a data processing unit that, when the document determining unit determines that the document is a monochrome document, selects the binary data stored to process the binary data as valid data, and when the document determining unit determines that the document is a color document, selects the multi-value data stored to process the multi-value data as the valid data.

2. The image reading unit according to claim 1, further comprising a data storing unit that performs a packing of the binary data, and stores the binary data on which the packing is performed.

3. The image reading unit according to claim 1, further comprising a data transfer unit that performs a packing of the binary data, and transfers the binary data on which the packing is performed.

4. An image reading unit comprising:
a document determining unit that generates first multi-value data of color components of Red, Green, and Blue and second multi-value data of a black component by scanning a document once with one reading unit for an image of a document, stores the first multi-value data and the second multi-value data in a storing unit, and determines whether the document is a monochrome document or a color document; and
a data processing unit that, when the document determining unit determines that the document is a monochrome document, selects the second multi-value data stored to process the second multi-value data as valid data, and when the document determining unit determines that the document is a color document, selects the first multi-value data stored to process the first multi-value data as valid data.

5. An image processing apparatus comprising:
an image reading unit including
a document determining unit that generates both multi-value data of color components of Red, Green, and Blue and binary data indicating black or white as a black component by scanning a document once with one reading unit for an image of a document, stores the multi-value data and the binary data in a storing unit, and determines whether the document is a monochrome document or a color document; and
a data processing unit that, when the document determining unit determines that the document is a monochrome document, selects the binary data stored to process the binary data as valid data, and when the document determining unit determines that the document is a color document, selects the multi-value data stored to process the multi-value data as the valid data; and
an image processing unit that performs an image processing on image data read by the image reading unit, wherein
the image processing is for at least one of an image formation and an image recording.

6. An image processing apparatus comprising:
an image reading unit including
a document determining unit that generates first multi-value data of color components of Red, Green, and Blue and second multi-value data of a black component by scanning a document once with one reading unit for an image of a document, stores the first multi-value data and the second multi-value data in a storing unit, and determines whether the document is a monochrome document or a color document; and
a data processing unit that, when the document determining unit determines that the document is a monochrome document, selects the second multi-value data stored to process the second multi-value data as valid data, and when the document determining unit determines that the document is a color document, selects the first multi-value data stored to process the first multi-value data as valid data; and
an image processing unit that performs an image processing on image data read by the image reading unit, wherein
the image processing is for at least one of an image formation and an image recording.

7. An image forming apparatus comprising:
an image processing apparatus including
an image reading unit including
a document determining unit that generates both multi-value data of color components of Red, Green, and Blue and binary data indicating black or white as a black component by scanning a document once with one reading unit for an image of a document, stores the multi-value data and the binary data in a storing unit, and determines whether the document is a monochrome document or a color document; and
a data processing unit that, when the document determining unit determines that the document is a monochrome document, selects the binary data stored to process the binary data as valid data, and when the document determining unit determines that the document is a color document, selects the multi-value data stored to process the multi-value data as the valid data; and
an image processing unit that performs an image processing on image data read by the image reading unit; and
an image forming unit that forms a visible image on a recording medium based on the image data processed by the image processing apparatus, wherein
the image processing is for at least one of an image formation and an image recording.

8. An image forming apparatus comprising:
an image processing apparatus including
an image reading unit including
a document determining unit that generates first multi-value data of color components of Red, Green, and Blue and second multi-value data of a black component by scanning a document once with one reading unit for an image of a document, stores the first multi-value data and the second multi-value data in a storing unit, and determines whether the document is a monochrome document or a color document; and
a data processing unit that, when the document determining unit determines that the document is a monochrome document, selects the second multi-value data stored to process the second multi-value data as valid data, and when the document determining unit determines that the document is a color document, selects the first multi-value data stored to process the first multi-value data as valid data; and
an image processing unit that performs an image processing on image data read by the image reading unit; and
an image forming unit that forms a visible image on a recording medium based on the image data processed by the image processing apparatus, wherein
the image processing is for at least one of an image formation and an image recording.

9. An image processing method comprising:
reading a document;
determining, after a completion of the reading, whether the document is a color document;
performing, when it is determined that the document is a color document at the determining, an image processing on color data of Red, Green, and Blue, which is read from the document and stored in a memory, as final data; and
performing, when it is determined that the document is not a color document at the determining, an image processing on binarized data of black, which is read from the document and stored in a memory, as final data.

10. A computer-readable recording medium that stores a computer program, wherein the computer program makes a computer execute
reading a document;
determining, after a completion of the reading, whether the document is a color document;
performing, when it is determined that the document is a color document at the determining, an image processing on color data of Red, Green, and Blue, which is read from the document and stored in a memory, as final data; and
performing, when it is determined that the document is not a color document at the determining, an image processing on binarized data of black, which is read from the document and stored in a memory, as final data.
